(19) United States
(12) Patent Application Publication
(10) Pub. No.: US 2007/0146137 A1
(43) Pub. Date: Jun. 28, 2007

(54) Article surveillance system

(76) Inventor: Per Claesson, Motala (SE)

Correspondence Address: HARNESS, DICKEY & PIERCE, P.L.C., P.O. BOX 8910, RESTON, VA, 20195, US

(21) Appl. No.: 10/580,175

(22) PCT Filed: Nov. 25, 2004
(86) PCT No.: PCT/SE04/01730

§ 371 Date: May 22, 2006

(30) Foreign Application Priority Data
Nov. 26, 2003 (SE) 0303161-4

(51) Int. Cl. G08B 13/14

(52) U.S. Cl. 340/572.4

(57) ABSTRACT

An electronic article surveillance system and method are disclosed. Pulses are emitted in an electromagnetic field, and in monitoring intervals between the pulses, reply signals are received from alarm labels within the surveillance area of the system. An incoming signal is sampled in the system. The zero crossings of the sampled signals are identified, and the phase positions thereof are compared with corresponding phase positions of zero crossings of an incoming signal, received and sampled in a previous monitoring interval. If these phase positions agree sufficiently well, an alarm can be initiated.

### FIELD OF THE INVENTION

The present invention relates to a method of detecting in an electronic article surveillance system whether an alarm condition exists according to the preamble to claim 1, and an electronic article surveillance system according to the preamble to claim 6.

### BACKGROUND ART

Electronic article surveillance systems, below referred to as EAS systems (EAS=Electronic Article Surveillance), are used in shops to detect attempted shoplifting. If a visitor without permission leaves a shop carrying an article, the system sounds the alarm.

Such systems are based on an antenna unit emitting an electromagnetic field. If an alarm label containing a resonance circuit comes within the surveillance area of the antenna unit (for instance at the exit of a shop), this circuit is brought into resonance by the field. When the antenna unit is switched off, the alarm label itself emits a weak signal which is captured by an antenna unit. In that case, an alarm, for instance a sounding alarm, can be initiated.

In prior-art systems, the received signal is mixed down to a low frequency or to a direct voltage. A problem with this approach is that it is susceptible to interference. Since the signal normally received from an alarm label is very weak, a source of interference at a great distance is sufficient to initiate a false alarm.

### SUMMARY OF THE INVENTION

An object of the present invention is to wholly or at least partly eliminate the above problem. This object is achieved by a method according to claim 1 and an electronic article surveillance system according to claim 5.

According to a first aspect, there is provided a method of detecting in an electronic article surveillance system whether an alarm condition exists. The article surveillance system emits, in transmission pulses, an electromagnetic field and receives, between the transmission pulses, reply signals from at least one alarm label which is located within the surveillance zone of the article surveillance system. The method comprises the steps of, after completed transmission of a transmission pulse, sampling a received reply signal, identifying zero crossings of the sampled reply signal, determining agreement between phase positions of the zero crossings and corresponding phase positions of zero crossings of a reply signal, received and sampled after a previously emitted transmission pulse, and making an alarm decision on the basis of the degree of agreement in phase position.

Such a method eliminates essentially the entire effect of sources of interference that are not in constant phase with the transmission pulse of the system and therefore enables much safer alarm detection than systems where an analysis is made on a mixed-down signal.

In a preferred embodiment, said previously emitted transmission pulse is the preceding transmission pulse.

Preferably, an alarm is initiated if the degree of agreement in phase position of the zero crossings exceeds a predetermined value.

In a preferred embodiment, the alarm decision can be made on the basis of an additional characteristic of the received reply signal, for instance the envelope of the received reply signal.

According to a second aspect, the invention relates to an electronic article surveillance system, comprising means for detecting whether an alarm condition exists, which article surveillance system in transmission pulses emits an electromagnetic field and between the transmission pulses receives reply signals from at least one alarm label which is located within the surveillance zone of the article surveillance system. The system is characterised by means for sampling a response signal, received after completed transmission of a transmission pulse, means for identifying zero crossings of the sampled reply signal, means for determining agreement between phase positions of the zero crossings and corresponding phase positions of zero crossings of a reply signal, received and sampled after a previously emitted transmission pulse, and means for making an alarm decision on the basis of the degree of agreement in phase position.

The system gives the same advantages as does the above-mentioned method and may be varied similarly.

### BRIEF DESCRIPTION OF THE DRAWINGS

FIG. 1 illustrates schematically components of an EAS system.

FIG. 2a illustrates schematically an EAS system in a transmission mode.

FIG. 2b illustrates schematically an EAS system in a reception mode.

FIG. 3 is a flow chart of a method according to an embodiment of the invention.

FIG. 4 illustrates functional modules of a control unit of an electronic surveillance system according to an embodiment of the invention

### DESCRIPTION OF PREFERRED EMBODIMENTS

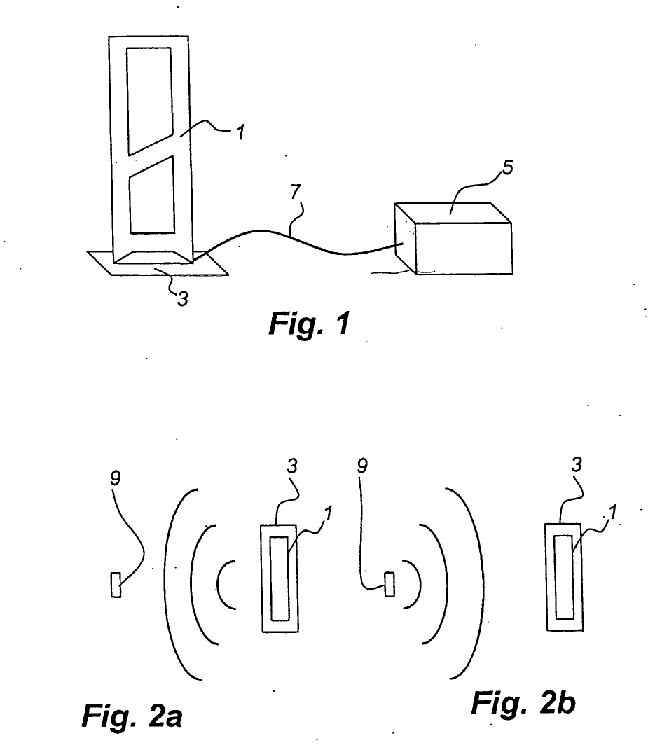

FIG. 1 illustrates schematically components of an EAS system. The system comprises at least one antenna unit 1, which in most cases is placed in the vicinity of the exit of a shop. The antenna unit 1 can be arranged on a stand 3 and contains a resonance circuit which is used to emit an electromagnetic field, for instance at the frequency 58 kHz. The antenna unit 1 is also used to receive a reply signal from an alarm label, as will be described below. The antenna unit 1 monitors a surveillance zone.

The antenna unit 1 is connected to a control unit 5 by a cable 7. The control unit 5 supplies power to the antenna unit 1 when transmitting and receives signals from the same during reception. A control unit 5 can be used together with a plurality of antenna units 1 and can therefore be used to monitor a plurality of exits or other locations in a shop. If the control unit 5 detects a condition when an alarm is justified, i.e. when a protected article is located within the surveillance zone of the antenna unit, an alarm is initiated, for instance so that an alarm buzzer (not shown) starts to sound. The alarm buzzer can be integrated, for instance, in the antenna unit 1.

FIG. 2a illustrates schematically, seen from above, an EAS system in a transmission mode. In transmission, the antenna unit 1 emits an electromagnetic field which transmits energy to an alarm label 9 which can also be referred to as a transponder. The alarm label 9 contains a resonant element, which is tuned with the frequency of the electromagnetic field emitted by the antenna unit 1.

FIG. 2b illustrates schematically, seen from above, an EAS system in a reception mode during a monitoring interval. In the reception mode, the previously shown control unit 5 has switched off the transmission of the antenna unit 1. Instead, a reply signal in the form of electromagnetic energy is received from the alarm label 9, i.e. the energy previously emitted by the antenna unit 1. Thus the alarm label 9 can be completely passive and does not require any power supply of its own.

Various configurations of antenna units 1 are conceivable. In some cases, use is made of an antenna unit, at an exit or some other location in a shop, both for transmission and reception. This means that one antenna unit is sufficient to monitor a surveillance zone. In other cases, use is made of two antenna units, which are used both for transmission and reception, which results in a larger surveillance zone. In still other cases, two antenna units are used, one for transmission and the other for reception, which is particularly convenient when protected articles are stored close to the antenna units.

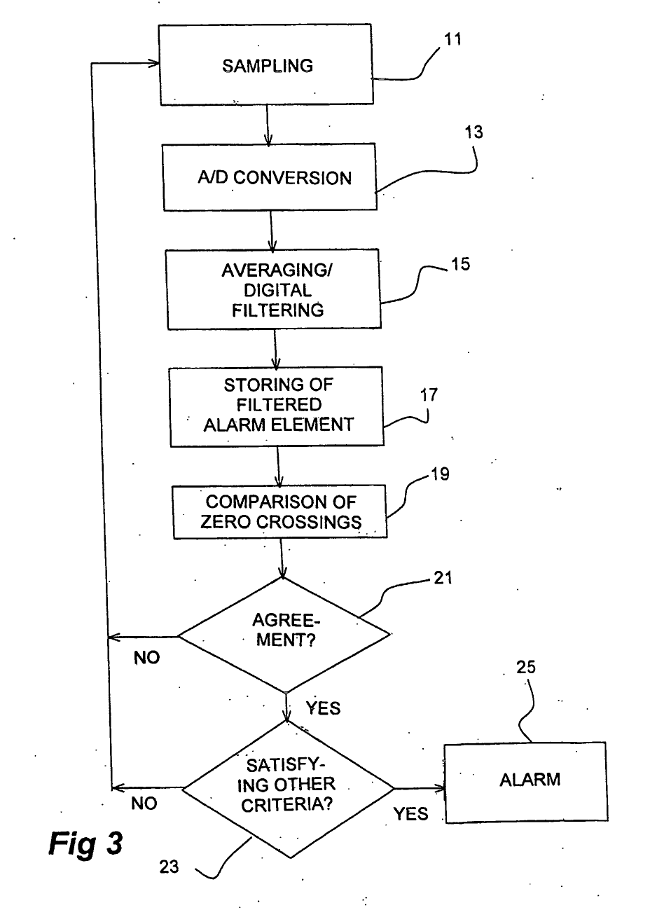

FIG. 3 is a flow chart of a method according to an embodiment of the invention. According to the method, an alarm decision is made, the risk of false alarm being very small.

In a first step 11, the received signal is sampled. In a preferred embodiment, only filtering and amplification of the received signal occur before sampling takes place. Thus, mixing down of the incoming signal usually does not occur. Filtering and amplification occur for the purpose of, for instance, eliminating interference from electric mains, lighting etc. If the EAS system itself transmits at 58 kHz, a bandpass filter thus is used, which is tuned to 58 kHz. If the expected signal frequency is 58 kHz, sampling may preferably occur at the frequency 400 kHz. The sampling is started a predetermined period of time after completion of the transmission pulse of the system and with a predetermined relationship to the signal phase of the transmission pulse, i.e. to the phase of the 58 kHz signal.

In a second step 13, the sampled signal is A/D converted. The A/D converted signal is stored in a buffer, preferably with double precision, i.e. 32 bits.

In a third step 15, the signal stored in step 13 is alpha filtered with the signal which in the same way has been stored and filtered after the preceding transmission pulse, i.e. in the preceding monitoring interval. By alpha filtering the following is meant

$$X ( n ) = \frac{{X}_{m}}{α} + ( α - 1 ) \cdot \frac{X ( n - 1 )}{α}$$

wherein Xₘ is the amplitude in a buffer position in the signal stored in step 13, X(n−1) is the result of the filtering of the corresponding buffer position in the preceding monitoring interval and X(n) the result of the filtering of the corresponding buffer position in this monitoring interval. α is a parameter, which is determined empirically, for instance α=16. Filtering is performed for all buffer positions. Thus alpha filtering is a kind of averaging, where signals not synchronised with the system, i.e. with the phase of the transmission pulse, are eliminated essentially completely.

In a fourth step 17, the result of the signal processing in step 15 is stored in a buffer, now with single precision, i.e. 16 bits.

In a fifth step 19, the zero crossings of the signal stored in step 17 are identified and compared with the zero crossings of a signal previously stored in the same manner and collected in a preceding monitoring interval.

It is checked in a sixth step 21 whether the phases of the zero crossings of these signals agree to a sufficient extent. By agreement is meant that zero crossings appear in corresponding positions in the buffer. For example, the criterion can be that 95% of the zero crossings must agree. If this is the case, it is quite probable that an alarm condition exists, i.e. that an alarm label is located within the surveillance area of the EAS system. The system then proceeds to a seventh step 23. Otherwise it returns to the first step 11 and awaits sampling in the next monitoring interval. The fact that the agreement of the phase positions is an excellent alarm criterion is due to the fact that alarm labels always have the same phase relationship with the pulsed field. Extraneous sources of interference within the same frequency band will “creep” in relation to the 58 kHz signal of the system.

In the optional seventh step 23, it is checked whether other criteria, if any, of an alarm condition are satisfied. For instance it may be convenient to check the envelope of the received signal, as is previously known per se. The envelope is clearly dependent on the Q value of the resonance circuit of the alarm label. If some other article has been brought into resonance by the transmission pulse of the system, the envelope will therefore have a different appearance.

If the other criterion is satisfied, the system initiates an alarm in an eighth step 25. Otherwise, it returns to the first step 11 where sampling occurs again after the next transmission pulse.

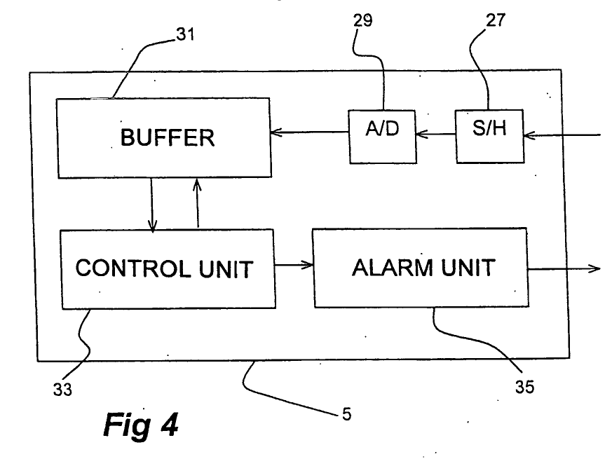

FIG. 4 shows functional modules of a control unit 5 of an electronic surveillance system according to an embodiment of the invention. It comprises a bandpass filter and an amplifier (not shown), a Sample/Hold circuit 27, an A/D converter 29 and a buffer 31 where output data from the A/D converter 29 are stored.

A control unit 33 reads data from the buffer 31, signal processes them, as described above, and stores the result in the buffer 31. Moreover the control unit 33 makes a check of the agreement between phase positions of the zero crossings of the signals, as previously mentioned, and also a check of other criteria. If the alarm criteria are satisfied, the control unit 33 initiates an alarm of an alarm unit 35.

It will be appreciated that the above functional modules can be accomplished in various ways, with software and hardware. For instance, it is preferred to accomplish the A/D converter 29, the buffer 31 and the control unit 33 with a digital signal processor (DSP).

In brief, the invention concerns an electronic article surveillance system, which in pulses emits an electromagnetic field, and in monitoring intervals between the pulses receives reply signals from alarm labels within the surveillance area of the system. An incoming signal is sampled in the system. The zero crossings of the sampled signal are identified, and their phase positions are compared with corresponding phase positions of zero crossings of an incoming signal, received and sampled in a previous monitoring interval. If these phase positions agree sufficiently well, an alarm can be initiated.

The invention is not restricted to the embodiments illustrated above and may be varied within the scope of the appended claims.

1. A method for making, in an electronic article surveillance system, an alarm decision, the article surveillance system being configured to emit, in transmission pulses, an electromagnetic field and being configured to receive, between the transmission pulses, reply signals from at least one alarm label located within a surveillance zone of the article surveillance system, the method comprising:
sampling, after completed transmission of a transmission pulse, a received reply signal;
identifying zero crossings of the sampled reply signal;
determining agreement between phase positions of the zero crossings and corresponding phase positions of zero crossings of a reply signal, received and sampled after a previously emitted transmission pulse; and
making an alarm decision on the basis of the degree of agreement in phase position.

2. A method as claimed in claim 1, wherein said previously emitted transmission pulse is the preceding transmission pulse.

3. A method as claimed in claim 1, wherein an alarm is initiated if the degree of agreement in phase position exceeds a predetermined value.

4. A method as claimed in claim 1, wherein the alarm decision is made on the basis of an additional characteristic of the received reply signal.

5. A method as claimed in claim 4, wherein the additional characteristic concerns the envelope of the received reply signal.

6. An electronic article surveillance system for making an alarm decision, the article surveillance system, in transmission of pulses, being configured to emit an electromagnetic field and between the transmission pulses, and being configured to receive reply signals from at least one alarm label located within a surveillance zone of the article surveillance system, the system comprising:
means for sampling a response signal, received after completed transmission of a transmission pulse;
means for identifying zero crossings of the sampled reply signal;
means for determining agreement between phase positions of the zero crossings and corresponding phase positions of zero crossings of a reply signal, received and sampled after a previously emitted transmission pulse; and
means for making an alarm decision on the basis of the degree of agreement in phase position.

7. An electronic article surveillance system as claimed in claim 6, wherein said previously emitted transmission pulse is the preceding transmission pulse.

8. An electronic article surveillance system as claimed in claim 6, wherein an alarm is initiated if the degree of agreement in phase position exceeds a predetermined value.

9. An electronic article surveillance system as claimed in claim 6, wherein the alarm decision is made on the basis of an additional characteristic of the received reply signal.

10. An electronic article surveillance system as claimed in claim 9, wherein the additional characteristic concerns the envelope of the received reply signal.

11. A method as claimed in claim 2, wherein an alarm is initiated if the degree of agreement in phase position exceeds a predetermined value.

12. A method as claimed in claim 2, wherein the alarm decision is made on the basis of an additional characteristic of the received reply signal.

13. A method as claimed in claim 3, wherein the alarm decision is made on the basis of an additional characteristic of the received reply signal.

14. An electronic article surveillance system as claimed in claim 7, wherein an alarm is initiated if the degree of agreement in phase position exceeds a predetermined value.

15. An electronic article surveillance system as claimed in claim 7, wherein the alarm decision is made on the basis of an additional characteristic of the received reply signal.

16. An electronic article surveillance system as claimed in claim 15, wherein the additional characteristic concerns the envelope of the received reply signal.
